(19) United States
(12) Patent Application Publication
(10) Pub. No.: US 2021/0306177 A1
(43) Pub. Date: Sep. 30, 2021

(54) Adaptable and Secure Can Bus

(71) Applicant: Kvaser AB, Mölndal (SE)

(72) Inventor: Lars-Berno Fredriksson, Kinna (SE)

(21) Appl. No.: 17/266,516

(22) PCT Filed: Aug. 7, 2019
(86) PCT No.: PCT/US19/45538

§ 371 Date: Feb. 5, 2021

Related U.S. Application Data
(60) Provisional application No. 62/715,781, filed on Aug. 7, 2018.
(60) Provisional application No. 62/755,686, filed on Nov. 5, 2018.
(60) Provisional application No. 62/807,291, filed on Feb. 19, 2019.

(51) Int. Cl. H04L 12/40; H04L 12/24

(52) U.S. Cl. CPC H04L 12/40104; H04L 12/40013; H04L 2012/40215; H04L 41/0816; H04L 41/0627

(57) ABSTRACT

A communication module is configured to communicate a first part of a message packet configured to identify message content contained in the message packet and a second part of the message packet and change the second part of the message packet in response to a trigger. A received message packet's changing portion is compared with the set of the authorized changing portions to determine whether the received message packet is authorized for the common control network. The received message packet is discarded or ignored in response to the received message packet's changing portion not matching at least one of the authorized changing portions in the set of the authorized changing portions.

### RELATED APPLICATIONS

This application claims priority to U.S. provisional application No. 62/715,781 filed Aug. 7, 2018; U.S. provisional application No. 62/755,686 filed Nov. 5, 2018; and U.S. provisional application No. 62/807,291 filed Feb. 19, 2019, each of which is incorporated by reference in its entirety.

### TECHNICAL FIELD

This invention relates generally to electronic communications and more specifically to a communication protocol for distributed control networks.

### BACKGROUND

A controller area network (“CAN”) protocol is an excellent and well proven protocol for controlling tasks in a distributed embedded control network. It is not well suited for networks that require security of messages or networks that require re-flashing of electronic control units (“ECUs”) which require a high bitrate. The main reason for this is that CAN protocol uses very simple bit transferring methods and low bitrate methods at the arbitration phase. The bit transfer methods used during the arbitration phase are outdated technology from the time when CAN protocol was conceptualized in the 1980s.

The CAN protocol was specifically designed to fit the needs of a distributed embedded controller network. Its most important properties were that:

1. There is no addressing. All nodes on a CAN network receive all messages and each node determines if the message should be received or not.
2. All nodes participate in the error handling. If all of the nodes do not find a message to be correct, then none of the nodes determine that the message should be received.
3. Bitwise arbitration is used for resolving message collisions. Thus, no message is lost, and the maximum latency of any message can be calculated.

These three properties solve a couple of general design problems in an efficient and elegant way. A first problem is data consistency within a distributed network. In a network that uses a CAN protocol, all nodes have the same information at any given time. A second problem is a predictable latency for messages communicated over the distributed network. A network that uses a CAN protocol is able to calculate the maximum latency time for both scheduled and unscheduled messages. In addition, not using an address scheme makes the messages in a CAN protocol network short because only a message identifier and a value have to be sent during runtime. Thus, the required bus bandwidth is minimized.

When CAN protocol was developed in the early 1980s, it was very efficient. It used the technology at hand to its most. The main features can be summarized as follows. First is data consistency; all messages are broadcast to all receivers, and every receiver checks for correct reception before accepting the message. Data consistency is a mandatory requirement of any safety critical system. Second is predictable latency. Messaging in a CAN protocol network can be scheduled in different ways (token passing, message sequence, time, etc.) and different types of schedules can be simultaneously combined. Unscheduled messages can be transmitted at any time with a predicable latency. Third is bandwidth efficiency. Only a CAN identification (“CAN ID”) and a value are transmitted during runtime. Any other information is transmitted during a setup phase. Fourth is that message avalanches at emergencies are avoided. Using CAN messages with no data for emergency messages, message avalanches at system failures can be easily avoided.

Accordingly, CAN protocol is an excellent protocol for distributed control systems. However, over the years new tasks have been assigned to CAN communication systems. One such task includes the flashing of ECUs. The ECU software is continuously growing, and using CAN protocol for this purpose was too slow. To mediate this problem Bosch started the development of CAN Flexible Data rate in 2011 resulting in the ISO standard 11898-1:2015 (known as “CAN FD” and which is incorporated by reference in its entirety). Using CAN FD protocol, the flashing could be done faster. However, modern systems demand more from distributed networks such as controller area networks. For example, protection against system hacking is required and requires data encryption and authentication of the transmitter, which creates more message overhead and, thus, longer messages. Initially CAN protocol was said to have a Hamming Distance of six, but it was later shown that a data bit mistaken for a stuff bit and vice versa could in some cases result in the same message length and the same CRC value such that the Hamming distance is only two. This is true also for CAN FD protocol.

Since the birth of the CAN protocol, the communication technology has developed tremendously, but CAN FD protocol has not taken advantage of that. For example, CAN FD protocol still uses the most primitive amplitude modulation for bit transmissions. Despite modern advances in the implementation of classic CAN protocols and CAN FD protocols, there are continued pressures for improved bandwidth in communication on common control networks typically controlled by CAN or CAN FD protocol communication systems. These pressures, however, are not related to a need for improved control of the network, i.e., distribution of control data in an efficient and reliable way. Instead, these pressures relate to issues of message encryption, authentication of the message's transmitter, and fast file transfer for ECU flashing.

### SUMMARY

Generally speaking, pursuant to these various embodiments, a proposed solution then is to separate the control issues from the non-control issues, thereby keeping a CAN protocol as the solution for the control issues. One such approach includes configuring a transceiver to establish a Virtual CAN Bus. Then, the physical layer can be designed to carry two or more protocols in parallel, and the transceiver multiplexes/demultiplexes the protocols. Thus, such a common control network can be said to have a Virtual CAN Controller (“VCC”) that can process CAN messages.

Specifically, the CAN signals are transmitted from a communication module's CAN controller to the transceiver according to the CAN standard, but, for example, only dominant edges and the bit value may be passed to the lower layers of the transceiver unit. The communication in the final system runs on a modern physical layer where the CAN bits are multiplexed and modulated. At reception, dominant edges and bit values of CAN signals are received, and the VCC restores the CAN bits and generates a signal that is sent to the CAN controller receiver connection. In this connection, for example, it is enough for the VCC to transmit, according to the CAN bus timing, the dominant edges and the bit value at the sample point.

Thus, by handling control tasks using a first protocol and other tasks using a second, different protocol the handling of the control tasks is separated from handling of other tasks. The distributed embedded control system can be fully developed using standard CAN Controllers and transceivers in a traditional way. Other tasks such as encryption, transmitter authentication, re-flashing, and the like can be carried out by other protocols running in parallel with the CAN protocol on the final communication physical layer. It is a great advantage to separate the control problems from other problems. The control problem can be addressed by the control experts (CAN protocols), and other problems can be addressed by experts in the respective technology fields (for instance, encryption, authentication, and the like). Any solution to problems in those fields can be implemented by modifying the physical layer, i.e., the transceiver and communication network. Moreover, by separating these protocols, the strengths of CAN based protocols can be used in communication media beyond common control networks where CAN protocol has historically been applied. These and other benefits may become clearer upon making a thorough review and study of the following detailed description.

### BRIEF DESCRIPTION OF THE DRAWINGS

FIG. 1 illustrates a functional block diagram of a communication module such a communication module of an ECU according to the present disclosure.

FIG. 2 illustrates a functional block diagram of a common control network including multiple communication modules are described with reference to FIG. 1 of the present disclosure.

FIG. 3 illustrates a representation of bit buildup using the prior art CAN FD protocol incorporated by reference above.

FIG. 4 illustrates the modulation of the signal voltages according to the prior art CAN FD protocol.

FIG. 5 illustrates the differential voltage during modulation and demodulation operations according to the prior art CAN FD protocol.

FIG. 6 illustrates bus signaling and receiver sampling according to the prior art CAN FD protocol.

FIG. 7 illustrates bus signaling and receiver sampling according to the present disclosure.

FIG. 8 illustrates a virtual CAN converter (VCC) receiving full bit from a CAN controller and returning only dominant edges and the bit values to the CAN controller.

FIG. 9 illustrates a VCC sending encoded sync segments to the protocol multiplexer.

FIG. 10 illustrates an AM-FM chart describing various bit various values transmitted in a CAN protocol network according to the present disclosure.

FIG. 11 illustrates a dominant ghost edge at the end of every bit that is used to keep a CAN controller according to the present disclosure in sync with the VCC.

FIG. 12 illustrates a CAN message frame according to classic can protocol.

FIG. 13 illustrates a bit embedding transmission according to the present disclosure.

FIG. 14 illustrates a bit embedding reception according to the present disclosure.

FIG. 15 illustrates a fake message embedding transmission according to the present disclosure.

FIG. 16 illustrates a fake message embedding reception according to the present disclosure.

FIG. 17 illustrates a time multiplexing based protocol for multiplexing a second protocol according to the present disclosure.

FIG. 18 illustrates a common control network operating only according prior art protocol J1939.

FIG. 19 illustrates a common control network have enhanced security according to the present disclosure.

FIG. 20 illustrates a security unit according to the present disclosure to integral to the CAN transceiver of a common control network according to the present disclosure.

FIG. 21 illustrates a schematic view of a portion of a message packet in a CAN protocol.

FIG. 22 illustrates a schematic view of portions of a message packet with identification and dynamic parts as configured in accordance with various embodiments of this disclosure.

FIG. 23 illustrates a schematic view of portions of a message packet with identification, semi-dynamic, and dynamic parts as configured in accordance with this disclosure.

FIG. 24 illustrates a schematic view of portions of the message packet with identification and mixed semi-dynamic and dynamic parts as configured in accordance with this disclosure.

FIG. 25 illustrates a schematic view of portions of a message packet with mixed identification, semi-dynamic, and dynamic parts as configured in accordance with this disclosure.

FIG. 26 illustrates a schematic view of portions of a message packet with identification, counter, and differently encrypted dynamic parts as configured in accordance with this disclosure.

FIG. 27 illustrates a schematic view of portions of a message packet with identification, counter, and differently encrypted dynamic parts as configured in accordance with this disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The proposed solution is to separate the control issues from the non-control issues, thereby keeping a CAN protocol as the solution for the control issues. One such approach includes configuring the transceivers of various nodes in the CAN network to have a virtual CAN bus. Thus, in such a configuration the physical layer of the CAN network will carry two or more protocols in parallel, and the transceiver at each node will multiplex/demultiplex signals carried on the physical layer to utilize the two or more protocols. The transceivers of the nodes of the CAN network also have a virtual CAN controller (“VCC”) that processes CAN messages in a specific way to address the multiple parallel protocols being used on the network.

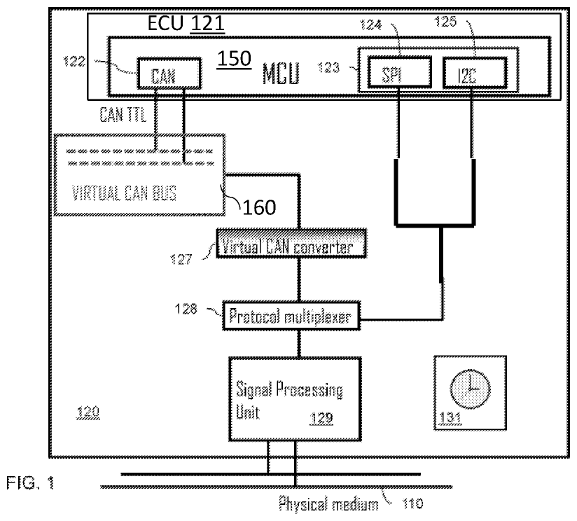

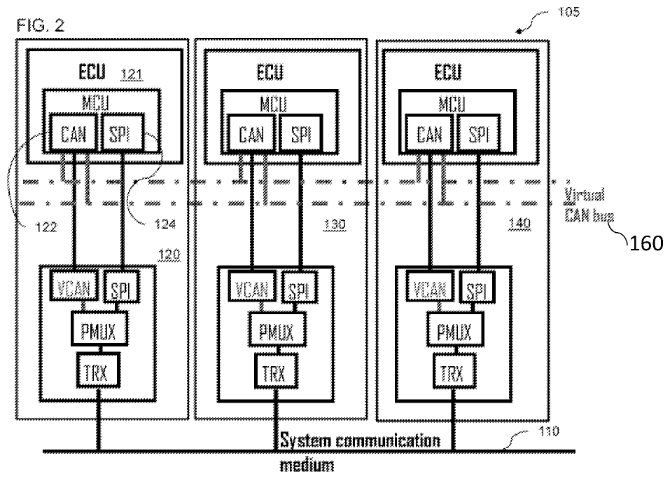

Referring now to the drawings and in particular FIGS. 1 and 2. FIG. 1 illustrates a single node in, for example, the common control network 105 illustrated in FIG. 2. The node illustrated in FIG. 1 is embodied as the communication module 120 of the common control network 105. The communication module 120 is connected to other nodes of the common control network 105 via a communication medium such as wire-based communication medium 110. The communication module includes a signal processing unit 129 coupled to the wire-based communication medium 110. The signal processing unit 129 is in turn coupled to a protocol multiplexer 128. The protocol multiplexer 128 is coupled both the virtual CAN controller 127 and the second protocol controller 123 of the MCU 150 of the ECU 121. The second protocol controller 123 may contain, for example a serial peripheral interface (SPI) module such as SPI module 124 and an inter-integrated circuit (I2C) interface module such as I2C module 125. The virtual CAN controller 127 is coupled to the CAN controller 122 of the MCU 150 of the ECU 121 through a virtual CAN bus 160. The protocol multiplexer 128 may be further coupled to one or both of the SPI module 124 and the I2C module 125. Each of the above described elements is capable of bi-directional communication with the other elements to which they are coupled. Each of the above elements is additionally coupled to clock 131. The clock 131 may be either a local clock or, example, a system clock received at the communication module 120 from an external source.

The virtual CAN bus is not a “bus” per se, but instead is a stream of signals received by the CAN module 122 that looks like signals the module 122 would expect to see from a traditional CAN or CAN-FD bus. This arrangement is created using the virtual CAN controller 127 that controls what the CAN module 122 received from the physical layer and signal processing unit 129. This virtual CAN controller 127 can also be considered an “intelligent” CAN controller as discussed below. virtual CAN controller 127

FIG. 2 illustrates a plurality of communication modules arranged to communicate over the common control network 105. The communication modules 120, 130, 140 are connected to send and receive message packets over a wire-based communication medium 110, commonly called a bus. The communication modules 120, 130, 140 and the communication medium 110 can be a considered common control network where every communication modules 120, 130, 140 is configured to receive every communication over the medium 110 or other wire-based networks. The common control network 105 described herein employs more than one protocol and the multiple protocols are used at each node. As such, each node may have, for example, one or more circuits or modules to process and separate the communications sent over the network according to the multiple protocols. In general, communications will have a CAN protocol format and another protocol format. The separation of the CAN formatted aspects from other protocols as described herein allow for application of this technology in a wide array of network topologies. In one example, individual ones of the message packets have a CAN format message packet and a payload data portion not using a CAN format and the CAN format message and data payload may be separated and used by the communication modules 120, 130, 140. Individual ones of the communication modules 120, 130, 140 may be, for example, electronic control units (ECUs) such as ECU 121 and comprise one or more processing devices configured to execute particular programming. For example, an ECU may execute a program that determines wheel speed or tire pressure. Those skilled in the art will recognize and appreciate that such a processing device may, for example, comprise a fixed-purpose hard-wired platform or can comprise a partially or wholly programmable platform. One well-known example is a microcontroller (“MCU”). All of these architectural options are well-known and understood in the art and require no further description here.

The modules 120, 130, and 140 include a CAN controller 122 and a second protocol controller 123. The CAN controller 122 functions in accordance with a CAN format including such as, for example, CAN or CAN FD. The second protocol controller 123 is configured to provide the payload data portion of a message packet sent by one of the communication modules 120, 130, 140 and to process the payload data portion of a received message packet received by one of the communication modules 120, 130, 140. In the illustrated example of FIG. 1, the second protocol controller 123 includes hardware and corresponding software for executing one of the serial peripheral interface (“SPI”) protocol 124 and the inter-integrated circuit (“I2C”) 125 bus interface protocols, both of which are well-known bus interface protocols. One skilled in the art will recognize that in a given application of these teachings only one of these examples may be implemented as the second protocol, or other protocols may be implemented by the second protocol control 123 instead of or in combination with the SPI and/or I2C protocols; for example, any known or future authentication or encryption protocols may be implemented as the second protocol in a second protocol controller 123 as called for in the given application.

The modules 120, 130, and 140 also include a virtual CAN controller 127 configured to convert CAN messages from the CAN controller 122 into CAN format portions of a message packet sent by one of the communication modules 120, 130, 140 and to send signals corresponding to aspects of the CAN format portions of a received message packet received by one of the communication modules 120, 130, 140 to the CAN controller 122. A protocol multiplexer 128 is configured to combine CAN format portions received from the virtual CAN controller 127 and the payload data portion from the second protocol controller 123 into the message packet sent by one of the communication modules 120, 130, 140 and to split the received message packet into the CAN format portions provided to the virtual CAN controller 127 and the payload data portion provided to the second protocol controller 123. A signal processing unit 129 provides the corresponding transmission signaling of the message packet sent onto the communication medium 110 or receiving the signaling of message packets received over the communication medium 110 from other communication modules 130, 140. Transceiver mechanisms such as the signal processing unit 129 are well known in the art.

Those skilled in the art will recognize and understand that such arrangements as illustrated in FIGS. 1 and 2 may be comprised of a plurality of physically distinct elements as is suggested by the illustrations. It is also possible, however, to view these illustrations as comprising respective logical views, in which case one or more of these elements can be enabled and realized via a shared platform. It will also be understood that such a shared platform may comprise a wholly or at least partially programmable platform as are known in the art. Indeed, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

A communication system such as those illustrated in FIGS. 1 and 2 can be used to execute a method of communication among two or more communication modules over a common control network including sending and receiving message packets where individual ones of the message packets have a CAN format message packet and a payload data portion not using a CAN format. The modules use a CAN format portion of the CAN format message packet for control issues on the common control network and the payload data portion in a protocol designed for data transmission, encryption, and data authentication aspects of the message packets. In this manner, the CAN controller manages the control issues for the common control network, wherein the CAN controller is isolated from the data payload portion of the message packets. More specific applications with respect to receipt of and transmission of message packets according to these teachings will be described in more detail below.

In one approach for receiving message packets, a method of communication among two or more communication modules over a common control network includes receiving at a first module of the two or more modules a message packet sent from a second module of the two or more modules. The message packet may have a CAN format message packet and a payload data portion not using a CAN format. The method includes splitting the message packet into a CAN format portion and the payload data portion followed by sending signals corresponding to aspects of the CAN format portion to a CAN controller such as CAN controller 122 and sending the payload data portion to a payload data controller such the second protocol controller 123.

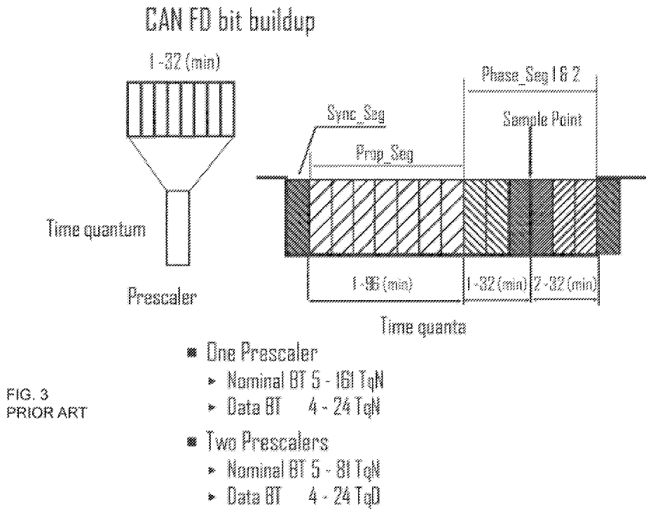

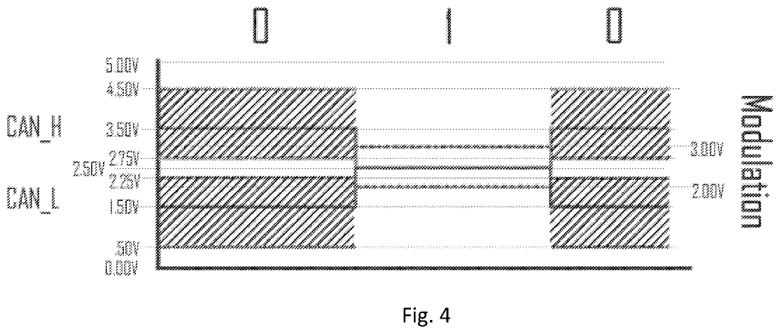

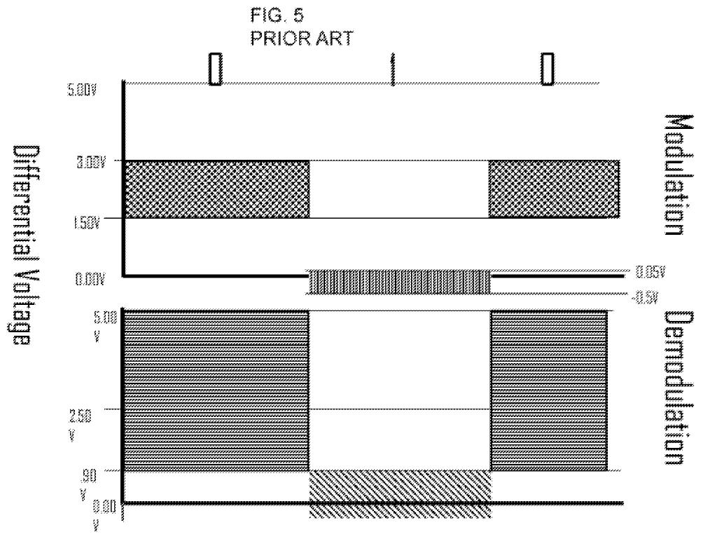

FIG. 3 illustrates a bit of data arranged according to the CAN FD protocol. According to the ISO standard 11898-1:2015, a CAN FD bit is constructed of time quanta. A time quantum (TQ) is a number of clock cycles. A bit starts with a Sync_Seg, one TQ long, followed by a Prop_Seg, a Phase_Seg 1, and a Phase_Seg 2. The value of the bit is sampled at the sample point located between Phase_Seg 1 & 2. The signal on the bus is amplitude modulated in the simplest way: a zero is voltage, a one is no voltage. FIGS. 4 and 5 illustrate example signal modulation rules according to CAN.

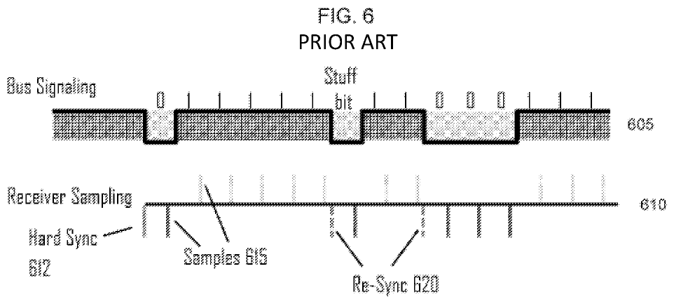

Referring now to FIG. 6, a peculiar thing with the CAN protocol is that the transmitter occupies 100% of the bus bandwidth when transmitting but the receiver is only looking for flanks from an idle bus (recessive state, continuous value of 1) to dominant value (0), denoted as a “dominant edge,” where it makes a hard synchronization of the bit clock. If the receiver samples the zero level at the sampling point, it regards the signal as a “Start Of Frame” (SOF) and continues to look for dominant edges (where it resynchronizes its bit counter) and samples the bit value at each sample point. Any other signal is ignored. Thus, the receiver is only using three time quanta of every received bit.

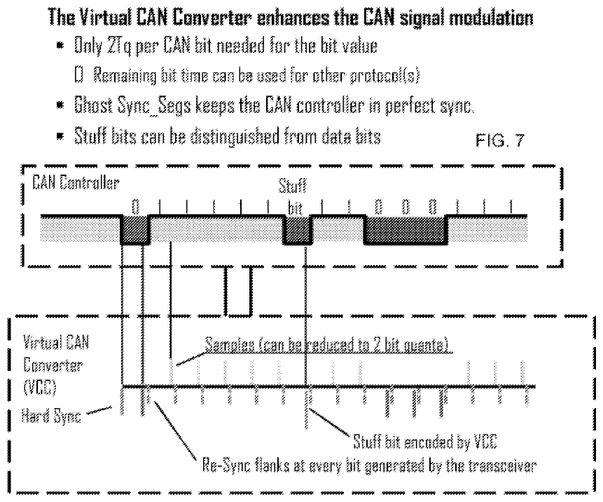

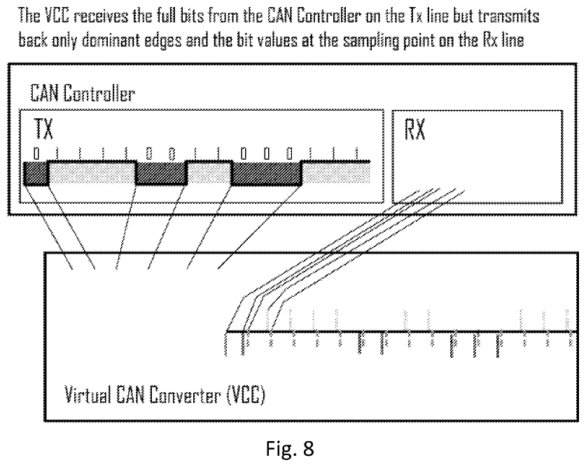

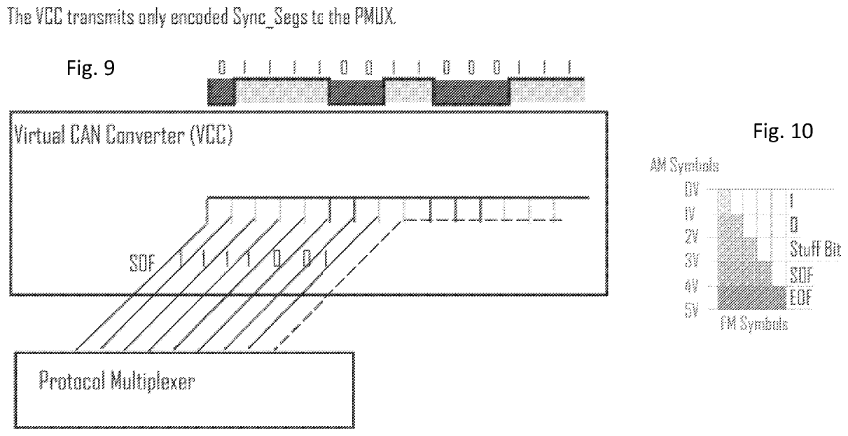

With this understanding, various applications of the method for receiving message packets in accord with this description will be described. In one approach, sending the signals corresponding to aspects of the CAN format portion of a received message packet to the CAN controller includes sending dominant edges and bit values at corresponding sampling points to the CAN controller 122's receiver. This approach can be implemented in a virtual CAN controller such as the virtual CAN control 127 and can be considered a reduced CAN protocol (“RCP”) that creates dominant edges at each Sync_Seg and at the bit value corresponding to each sample point. As illustrated in FIGS. 7-9, this approach occupies only one time quantum for the Sync_Seg and two time quanta for the bit value.

FIG. 6 illustrates conversion of a received message from the CAN signaling 605 having values of zero, one, one, one, one, one, stuff bit, one, one, zero, zero, zero, one, one, one into signals provided only at the sampling points needed for a CAN controller to understand the above values. The first signal is a hard sync 612, followed by voltage signal pulses 615 corresponding to the respective CAN values at the respective sampling points. By sending short pulses instead of a maintained voltage level, the remainder of the space is available for other uses. Re-sync values 620 are provided at the falling edges for clock synchronization purposes. According to the CAN protocol, Phase_Seg 2 should be no shorter than two time quanta. Then the VCC can make a recessive TQ at the Phase_Seg 2 of a dominant bit to create a dominant edge at every bit. However, in the case of FIG. 6, the CAN Controller ignores any dominant edge after sampling a dominant value so such an edge will not cause a resynchronization. Worst case would then be six bits before the CAN Controller resynchronizes (after five consecutive 0's and a stuff bit).

The RCP, as illustrated in FIGS. 7-9 may be further configured to generate a dominant edge at the end of every bit, i.e., a “Ghost Synch_Seg” at each bit instance where the CAN Controller is not generating recessive bit followed by a dominant bit (1/0). The application of the ghost edge will keep the CAN controller in synch with the VCC. According to the CAN protocol, a stuff bit of the opposite value should be transmitted after five consecutive bits of the same value. As described earlier, this causes some problems with the Hamming Distance. The virtual CAN controller may be configured to modulate the stuff bits and send an error frame if a stuff bit is detected at a wrong place. The optional generation of ghost edges after dominant bits could be of value for the protocol multiplexer. When the CAN controller transmits, the VCC receives full bits, i.e., a differential voltage shifts when two consecutive bits have different value, from the transmission line of the CAN controller. In response to receiving the full bits, the VCC creates at least a Sync_Seg and a bit value at the sample point at for each respective bit and feeds them back to the reception line. Ultimately, only a modulated Sync_Seg has to be sent between the VCC and PMUX. By the modulation, the bit value is encoded, and if the bit is a SOF, a data bit, a stuff bit or an EOF, the VCC will create the two TQs required for the CAN controller to read the voltage level at the sample point. Thus, a message packet including a CAN message format frame as discussed herein does not necessarily include every aspect of a CAN protocol message, but instead includes only those aspects necessary for taking advantage of the benefits the CAN protocol such as the Sync_Seg.

The length of a CAN message can be very important. Therefore, it is an advantage if the VCC in communication with the protocol multiplexer (“PMUX”) generates an encoded SOF bit at the beginning of a message and an encoded EOF bit at the end of the message. The RCP should then have the capability to generate three specific encoded bits: SOF, EOF, and Stuff Bits. The encoding can be done in many different ways, for example, by amplitude modulation or phase modulation. The time quanta on the CAN controller side can be different (preferably longer) from the PMUX side (preferably shorter) because the CAN controller side is limited by older technology, but the PMUX can use modern and faster technology. Each Sync_Seg signal at the CAN controller side can be modulated on the PMUX side to immediately also carry the bit value. Because the connection between the CAN controller and the VCC is a short Point-to-Point connection, the risk of disturbances is very low, and the signal quality can be constantly supervised and acted on.

The basis for the protocol multiplexing is the CAN message frame generated by the RCP at the VCC. Such a frame is initiated either by the CAN controller or the PMUX. The timing of the RCP signals are kept by and through the PMUXs and the Signal Processing Units so the VCCs can accurately create the virtual CAN bus. With reference to FIG. 10, a CAN message frame starts with the dominant SOF bit followed by the Identifier Field and one more bit (i.e., the RTR bit in classical CAN or the RRS bit in CAN FD). These bits can be sent simultaneously from two or more CAN controllers. The ACK bit is sent from all receiving CAN controllers. This can cause some difficulties for the PMUX and the RCP. When a bit value is received while more than one CAN controller is transmitting, the bit value can appear anywhere in the Prop_Seg of the CAN bit. The RCP is configured to catch it and transmit it to the CAN controller at the sample point. There are (at least) two ways to solve the problem: 1) send the bit value continuously on the communication in the part of the CAN Frame where multi-transmissions are allowed such that any second protocol signal is blocked, or 2) modulate the CAN bit values and dominant edges in a way that they can be filtered out at the right time and position of the CAN frame.

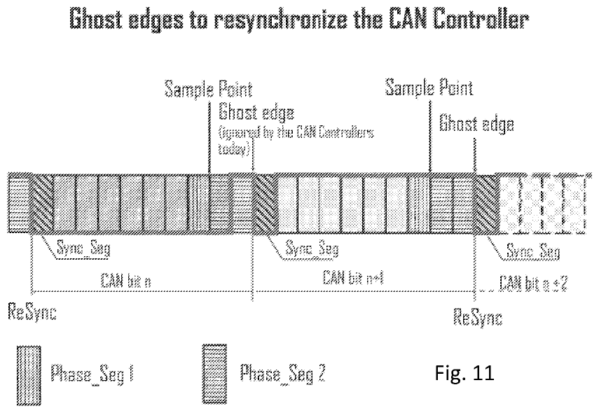

FIG. 11 illustrates one example of converting a message from the CAN controller into a combined message for transmission on the signaling medium or bus. The CAN controller transmits a message to the VCC, which then reduces the message's bits to dominant edges and bit values. Because the connection between the CAN controller and the VCC is point-to-point and the VCC generates ghost edges, the Sample Point can be moved as far as possible to the end of the bit. In one approach, the Phase_Seg 1 is one TQ and the Phase_Seg 2 two TQ long. The VCC transmits the Sync_Seg to the PMUX. The PMUX has full knowledge about the protocols it can handle and thus also how long it will take from the time the Sync_Seg is received until the bit value is expected. After each Sync_Seg, the PMUX fills the void with bits from the second protocol and passes the bit stream to the Signal Processing Unit. For example, U.S. Pat. No. 8,737,426, which is incorporated herein by reference, describes in detail how bits according to a first protocol can be embedded into bits of a second protocol. As mentioned earlier, some signal modulation could have been done already at the VCC and Protocol Multiplexing level, e.g., Sync_Seg of SOF, Stuff Bit, and EOF could have been distinguished from data bits as well as the second protocol could follow other modulation and multiplexing rules. Importantly, the VCC can position the Sync_Segs and the bit values at the correct instances in time for the CAN controller in a way that isolates it from the embedded protocol such that the portion of time on the bus dedicated to the embedded protocol need not follow any CAN protocol rules.

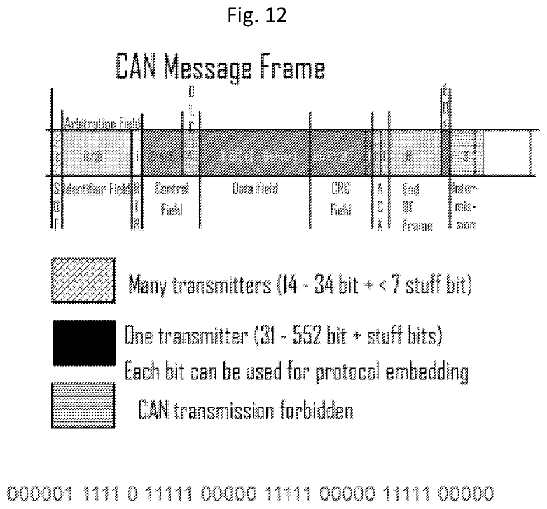

As illustrated in FIG. 12, receiving modules are processing the signals in a reverse order. A bit stream is received from the SPU and demultiplexed by the PMUX. The CAN signals according to the RCP is fed to the VCC and the bits of the second protocol to the second protocol handler.

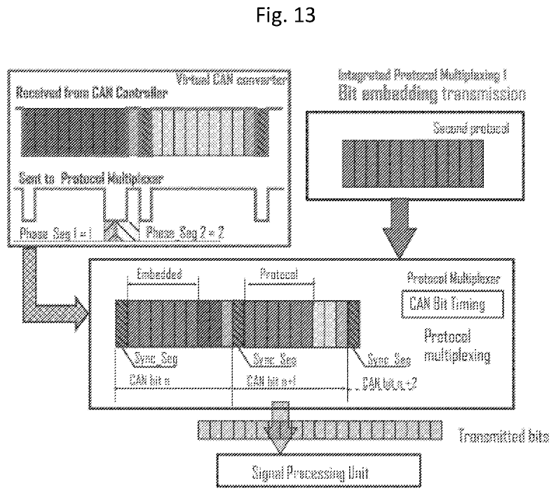

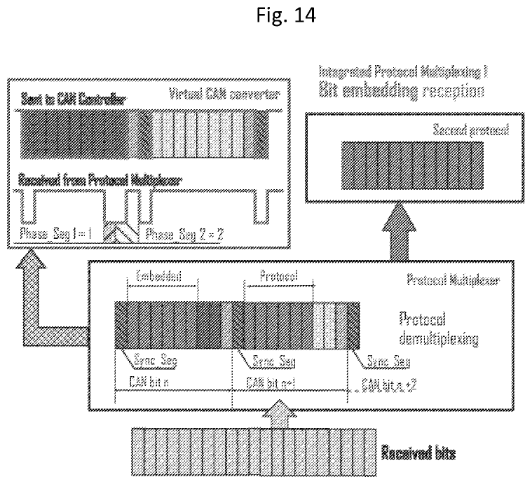

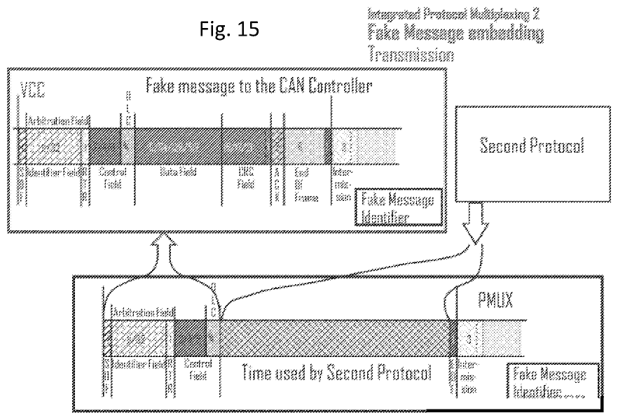

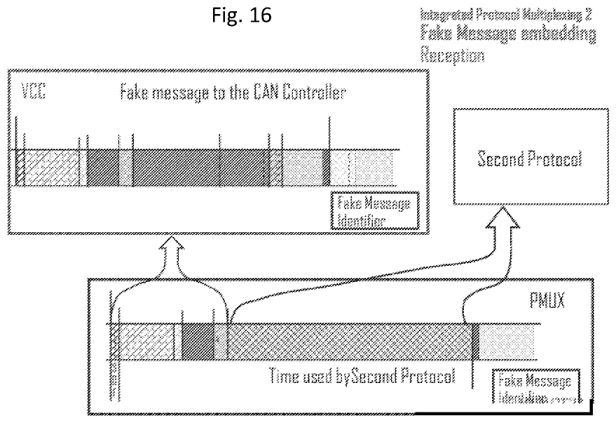

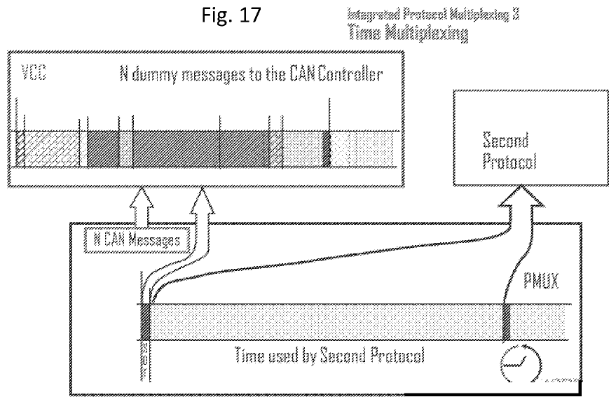

Another method to embed a second protocol is to send a fake CAN message, examples of which are illustrated in FIGS. 13 and 14. One CAN identifier is reserved for this purpose and known by the PMUX and the VCC. When the PMUX wants to transmit something from the second protocol, it starts the transmission as a CAN message with the reserved identifier, and a DLC creates a time slot that can be occupied by second protocol bits until the EOF. All VCCs will receive the first part and transmit it to their respective CAN Controller (bit by bit). If the fake message wins the arbitration, the respective VCC will create a fake message and send it to their respective CAN controllers. The PMUX will use the time until EOF for transmission of second protocol bits. More than one CAN identifier can be reserved and used to distinguish messages of specific kinds and addresses and/or to identify a third or fourth protocol, etc.

Sometimes the control system only uses a fraction of the available bandwidth. One way to make a window for the second protocol is to set up a number of dummy messages. These dummy messages are sent back-to-back to the CAN controller to correspond to an amount of time needed to complete the second protocol's message. A dummy message having the CAN Id Std0 will block the CAN controller from any attempt to transmit a message. During runtime of a control system, i.e., the CAN system, some messages have to have the highest priority e.g., at catastrophic situations. The dummy message should then have a lower priority. The VCC would then detect an attempt to transmit the alarm message but too late for the PMUX to transmit it. The VCC can then create a bit fault to the CAN controller. The CAN controller will respond with an error frame and retransmission of the alarm message. The PMUX will now get a SOF, abort the Second Protocol message and continue transmitting the alarm message.

### Summary of the RCP

The Reduced CAN Protocol generates the position and values of the essential bit quanta in a CAN message and the different frame structures from Start Of Frame (SOF) to End Of Frame (EOF) according to the chosen CAN format for the actual system. When the CAN controller transmits, the VCC mirrors the TX signal to the RX connection and conveys the following reduced CAN signals to the PMUX:

1. The Sync seg of every bit
2. The bit value by one or any combination of the alternatives below:

a) modulating the Sync Seg

b) modulating the first TQ of the Prop_Seg

c) last TQ of Phase_Seg 1 and first TQ of Pase_Seg 2

### 3. Encoded Stuff Bits

### 4. Encoded SOF

### 5. Encoded EOF

At reception the PMUX transmits the CAN primitives according to the RCP to the VCC. The VCC converts the primitives to CAN bits on the go and feeds the signals to the CAN controller. The VCC also checks the bit flow according to the Stuff Bit rules. In case of a mismatch, it transmits an error flag both to the CAN controller and the PMUX.

Those skilled in the art will recognize that a wide variety of modifications, alterations, and combinations can be made with respect to the above described embodiments without departing from the scope of the disclosure. For instance, the above detailed description assumes that the ECU has a CAN controller. This makes it easy to apply these teachings because old ECUs can be used without any modification. For completely new designs, it could be an advantage to move the CAN controller to the transceiver unit. There are already many such designs for both for classical CAN and CAN FD, denoted as “Standalone CAN Controllers.” In this case, the transceiver unit should have two modes, a “CAN Only Mode” and a “CAN Embedded Mode.” In CAN Only Mode, the PMUX is bypassed, and the signals according to the RCP are sent directly to the bus. In this way the control system can be developed in a straight forward way with well proven CAN tools. As only the essential signals are transmitted on the CAN bus, detailed time analysis of the communication can be made. In a later stage of the development when other features are added to the communication, the CAN control part can be verified by analyzing the virtual CAN bus by examining the RCP signals from the PMUX. Such modifications, alterations, and combinations are to be viewed as being within the ambit of the inventive concept.

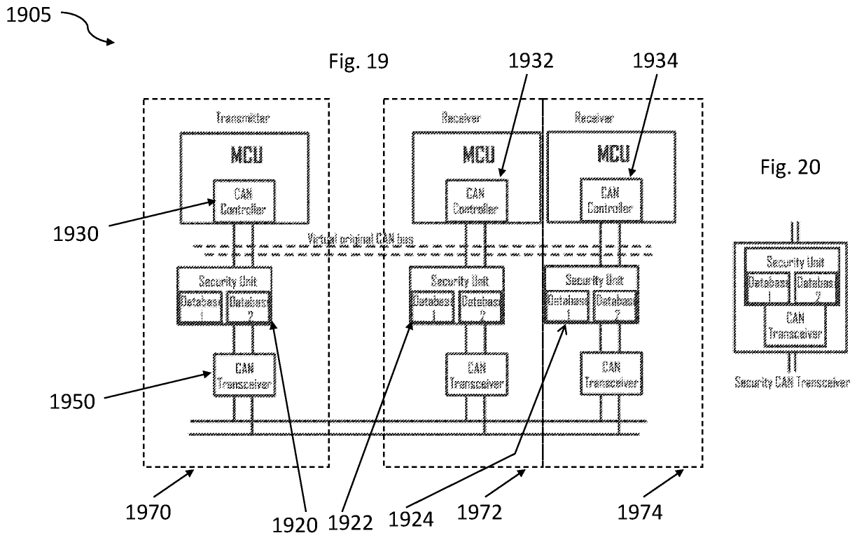

Referring now to FIG. 19, the security of a common control network such as common control network 105 may be improved by adding a security unit 1920 to each of the communication modules of the common control network. With reference to FIG. 2, security units 1920 may be added to each of the communication modules 120, 130, 140. The security units 1920 may be connected between, for example, a CAN transceiver 1910 and a CAN controller 1930 of communication nodes 1970, 1972, and 1974 of common control network 1905. Some or all of the nodes of the common control network may have a security unit such as the security unit 1920. In another implementation, the security unit as discussed herein can be incorporated into the VCC discussed above. Consistent with FIG. 20, the CAN transceiver may be integrated into the same physical package and the security and they may be replaced without replace other parts of the communications nodes 1970, 1972, 1974.

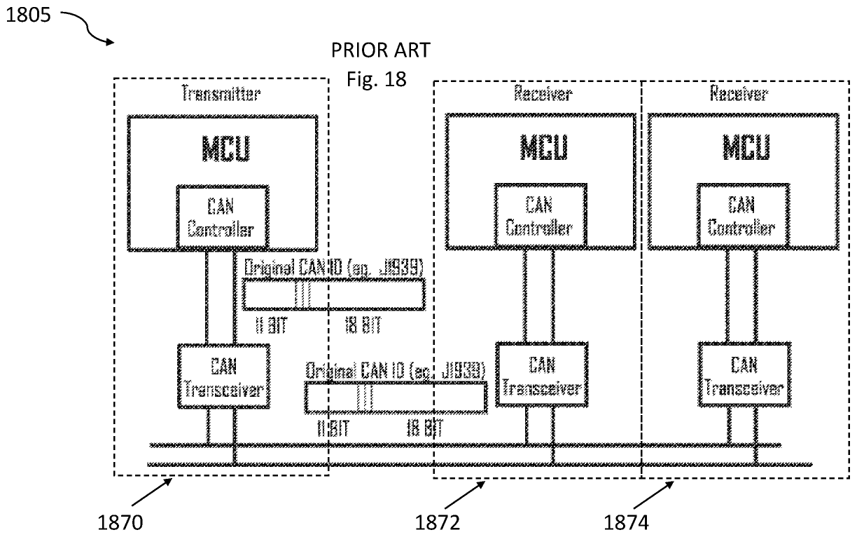

FIG. 18 illustrates a common control network 1805 according the prior art. In the prior art, a transmitting communication node 1870 sends communication packet having a CAN ID, according to, for example, CAN standard J1939. This packet has an arbitration field that may comprise of, for example, a first 11-bit identifier and a second 18-bit identifier. The second 18-bit identifier is an extension of the first 11-bit identifier and can be included or not based on the value of other bits in the communication packet. The arbitration field specifies the priority of a given packet, and in CAN protocols ensures that the packet with the highest priority is broadcast by a common control network using a CAN protocol. Arbitration in classic CAN may be performed according to, for example, carrier sense multiple access with collision detection (CSMA/CD).

The receiving communication nodes 1872, 1874 of the common control network 1805 then receive the communication packet having the CAN ID that was generated the transmitting communication node 1870. The communication packets sent in this manner are insecure. The common control network 1905 is secured by the addition of one or more security units 1920.

The common control network 1905 depicted in FIG. 19 separates security functionality from control functionality. is a great advantage to separate the security functionality from the control functionality as any changes in or changes to the control application will require a genuine re-testing of the system to make sure the control system still meets it performance requirements. The security can be successively be enhanced by just exchanging the existing security unit for a new one using the latest technology. The secure higher layer protocol disclosed herein inserts a cryptographical generated number into the second or extended identifier field of the CAN protocol described above. It should be appreciated that a cryptographic number of less than 18 bits may be inserted and other information such as a timestamp or a message sequence number may be included. The arbitration method, CSMA/CD, of the prior art need not be modified.

A transmitting communication node 1970 of the common control network 1905 first transmits a communication packet according to, for example, CAN standard J1939. Prior to being broadcast of the CAN transceiver 1950 to the CAN ID generated according to, for example, J1939 is received by the security unit 1920 and security unit 1920 adds authentication information such as a cryptographically generated number to the 18-bit identification field. The security unit 1920 then transmits a reduced CAN ID having an 18-bit authentication field to the CAN transceiver 1950. The CAN transceiver 1950 then broadcast the communication packet having the reduced CAN ID and the authentication information to the receiving nodes 1972, 1974 of the common control network 1905. The security units decode/decrypt the CAN ID and transmitted the decoded/decrypted communication packet to the CAN Controllers 1932, 1934 of the receiving communication nodes 1972, 1974.

Each of the security units 1920, 1922, 1924 of the communication nodes 1970, 1972, 1974 may have the same structure and configured as follows. The security units may contain, for example, a first and second data for storing various authentication information according to the present disclosures. Though not illustrated, it should be understood that the security units 1920, 1922, 1924 each contain at least processing circuit capable of implementing the here described functionality. The security units may for example collect and store the CAN identifiers used by the common control network 1905 and store them in a first database. The security units 1920, 1922, 1924 may, when an additional identifier is identified or all at once, transform the CAN identifier used by the common control network 1905 into new 11-bit identifiers with the same priorities the untransformed CAN identifiers stored in the first database. After transforming the CAN identifiers, the transformed CAN identifiers may be stored in a second database of the security units 1920, 1922, 1924. The first and the second databases are non-secret and can be downloaded using troubleshooting tools.

After or when the transformed CAN identifier are stored in the second database, authentication information of up to 18 bits may be appended to the transformed CAN identifier. The 18 bits of authentication information may be, for example, a 18-bit cryptographically generated number. However, as described above, the other information may be included in the authentication information and the cryptographically generated number may be less than 18 bits. The cryptographic number by be generated using, for example, known cryptographic key generating algorithms. Such algorithms include those algorithms that generate a symmetric key and upon generating such a key the security units 1920, 1922, and 1924 may distribute the symmetric key to each other of security units 1920, 1922, 1924.

The common communication may be switched to secret mode and use the CAN identifiers stored in the second database with their appended 18 bit authentication information.

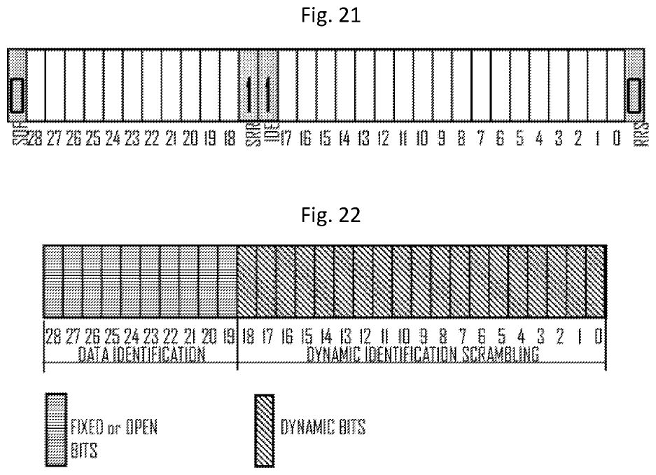

Generally speaking, pursuant to these various embodiments including specifically the embodiments of FIGS. 1, 2, 18, and 19 or any combination thereof, a method of operation for a first communication node communicating on a common control network includes communicating from a communication port of the first communication node onto the common control network a first part of a message packet configured to identify message content contained in the message packet and a second part of the message packet and changing the second part of the message packet in response to a trigger. In the context of the CAN communication protocol, the message parts can be understood in the context of what different bits of the protocol represent, which in turn changes how receiving nodes react to receipt of these messages. More specifically, the first 33 bits on the bus of a CAN message is organized in the same way for Classical CAN and CAN FD (both being known communication standards). FIG. 21 illustrates these first 33 bits of a message packet under either CAN or CAN FD. The packet begins with a Start Of Frame bit (SOF), always a zero, followed by 11 message identifier bits. This set of 11 bits is a legacy of the first version of CAN (that had an eleven bit message identifier) now called Classical CAN. The next bit is the Substitute Remote Request bit (SRR) that indicates that this is not a remote request message, and the following bit is the IDentifier Extension bit (IDE) that indicates we have an extended identifier of 29 bits. The identifier part of the message is ended by the Remote Request Substitution bit (RRS). According to the ISO 11898 CAN standard, the first 11 bits are enumerated from 28 to 18 and the remaining identifier bits from 17 to 0, as illustrated in FIG. 21.

Turning to FIG. 22, the bits enumerated from 28 to 0, therefore, constitute the identifier bits that can be spilt into a fixed data identification portion made up of fixed or open bits and a dynamic identification portion made up of dynamic bits. In a fixed implementation, the fixed bits do not change; in an open implementation, these bits are open for being understood by any receiver. In this CAN context, the open bits are readable by any CAN receiver whereas the dynamic bits constitute the second portion of message that changes in response to a trigger. The trigger can take many forms including passage of a given time period, receipt of a given number of received messages, sending of a given number of sent messages, receipt of an alert message at the communication port, and combinations thereof. The way in which the second part of the message packet is changed can also take many forms. In one approach, several versions are stored in a lookup table such that changing the second part of the message packet is performed by switching to a different value in the lookup table. In another approach, the changing bits can be changes via application of an algorithm. Any algorithm that can change the bits can be suitable; although use of more advanced cryptography can be used in certain situations.

Speaking more generally, by using only a limited number of bits in the beginning of the bits to identify the different identifiers or parameters in a system, the remaining bits can be used to scramble the message. Any tool could then read any message by just regarding the parameter identification part (i.e., the open bit portion) of the CAN identifier and ignoring the remaining part. To transmit a valid control message, the complete CAN identifier must be correct. Otherwise the message will be ignored by the receiving nodes.

In the following examples, one message part identifies the message content and one or more dynamic message parts dynamically change the identifier of the CAN message. To make the presentation of the different methods simple, the examples use the first ten bits for content identification (allowing 1024 different contents) and the remaining 19 bits for scrambling, but other combinations of fixed and changing could be used. FIG. 22 shows an example where the first 10 bits contains a static message identifier, and the following 19 bits are used for scrambling the identifier. Theoretically a message that allows a module to give the command on the bus will use one out of 524,288 possible ones but which one at any instant in time is depending on system rules.

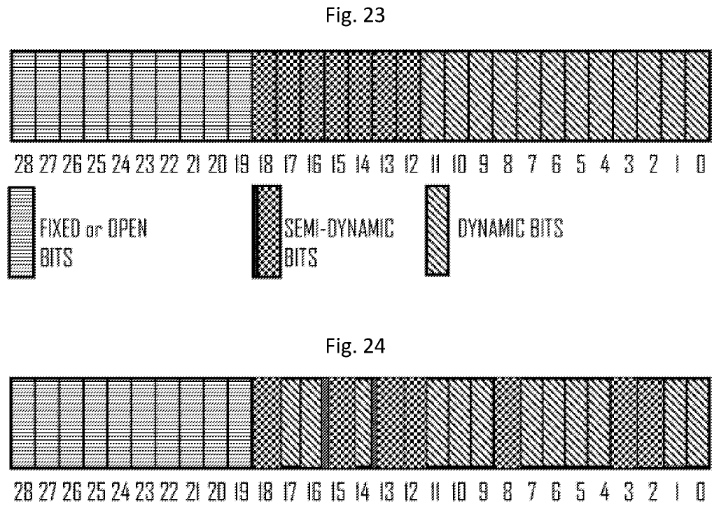

Other patterns can be used. For instance, one group of messages identifiers could be completely open allowing third parties to transmit “safe” control messages, one group where control messages could be read by third parties but should not be transmitted by a third party for security purposes, and a third group of messages that are “semi dynamic” where the certain bits in the dynamic part are changed at certain instants or instances, e.g., once a day, when a certain message is received, or when commands are executed at certain conditions, e.g., if in a vehicle, when the vehicle is operating at a low speed or in a low gear. FIG. 23 shows a simple example where the first seven bits of the dynamic part is used for semi-dynamic bit patterns.

To make reverse engineering a bit more difficult, semi-dynamic and dynamic bits can be scattered over the dynamic part as illustrated in FIG. 24. The pattern can be changed dynamically as well, e.g., triggered by events or time or the pattern is different in different individuals of systems of the same kind.

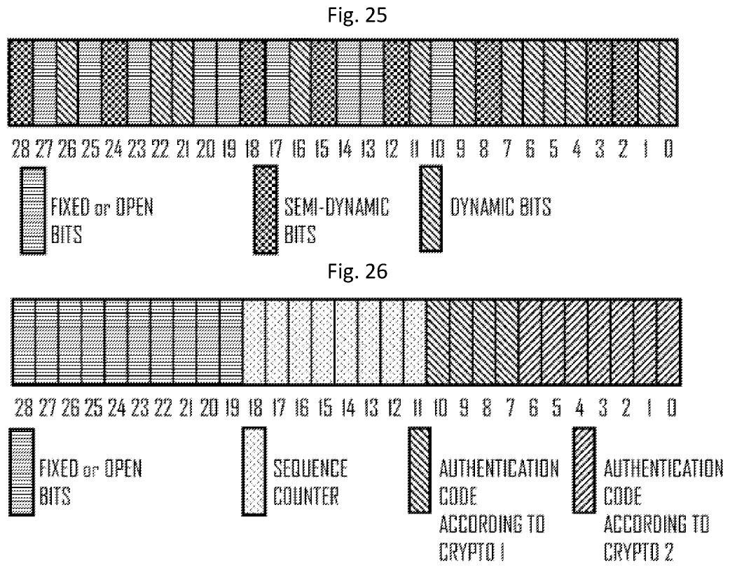

Even the message identifier bits can be scattered as shown in FIG. 25. This can be used to make different individuals somewhat unique to prevent fleet hacking. A tool may send out a specific message to the system and the system would then respond with a message telling where to find the fixed bits. The idea of CAN identifier scrambling can be used as a base for a multitude of methods for making system hacking difficult. Additional examples are described below.

Method 1, changing the identifiers when a hack attempt is detected.

The system can be designed in a way that control messages are sent frequently enough that even if a false command is received by the ECUs, the system is stable and secure until the next control message is received. In this example, the nodes on the common control network are programmed to react in such a way so as to immediately change the dynamic part of the message in a particular way in response to receiving a “system under attack” message. Alternatively, each node changes the dynamic part in the same way, but because the non-affected nodes ignore any message that does not contain information related to their software, only the affected ones have to change. The system can be designed to go into a safe state if a second “system under attack” message is received within a certain period of time. Because the system is changed only when an attack is detected, the number of alternative identifiers can be low and stored in a lookup table.

Method 2, a scheduled change of identifiers.

In this example, the system can overcome the possibility for a hacker to partly take over control by sending a copy of an authorized message identifier with false data (that would give him the possibility to have 50% control) would be to schedule all messages to not transmit another message until four time quanta has passed and not accept a control message immediately followed by a “system under attack” message. To make the hacker task even more difficult, the identifiers could be changed according to a schedule. This can be done in many different ways. The identifiers could be modified periodically or at every message and the identifiers can be changed according to a table or by an algorithm. The basic algorithm can be generic and individually modified for specific systems by a set of constants during a setup phase. The limit of possibilities is set by the system designer's knowledge in cryptography.

Method 3, a combination of cryptographic authentications.

FIG. 26 shows another example implementation. As before, the first part of the CAN identifier defines the content of the data field. Some standards require a message counter to secure that one and the same message is not received and acted on by mistake. To satisfy such a requirement, an eight bit message or sequence counter follows the identifying part. One problem with crypto is the key distribution. For a specific system, e.g., a vehicle, a key can be generated and stored in a way that it is very difficult for anyone to later find, e.g., by scattering the value over a non-volatile memory in one or more respective nodes. Once such a system is generated, functions protected by the encryption with such a key are very difficult to change in an illegal way because the key is in situ protected. However, if the key is not destroyed after it is distributed in the system, the protection is not better than the protection of the key. A way to further protect the system is to use multiple keys and use each key at a given number of the message counter. This is similar to requiring two people each having a personal key to open a vault. However, there may be situations where several people have to have the possibility to provoke the system from a service tool, e.g. for troubleshooting, and then a weaker protection of the key has to be accepted. FIG. 26 shows two parts at the end of the identifier where the identifier value is changed by a cryptographic number generator generating pseudo random numbers according to the key. The first part is generated by a first key that has a weaker protection than a second key. The respective control node will accept the execution order during specific conditions, e.g., the first gage is engaged or the speed is below 10 mph (miles per hour), if the first number is matching. The second number is then ignored. If a higher gear is engaged or the speed is higher than 10 mph, then the second value has to be matched.

An advantage to using cryptographic methods to manipulate the CAN identifier only, not the data itself, is that such a process can be implemented in an “intelligent” CAN transceiver or VCC. The protection is taken care of by one component that only has to be implemented in modules capable of controlling safety critical tasks. All other modules can be equipped with ordinary CAN transceivers and no control software has to deal with the system protection problem because any compromised message is stopped before reaching any safety critical application.

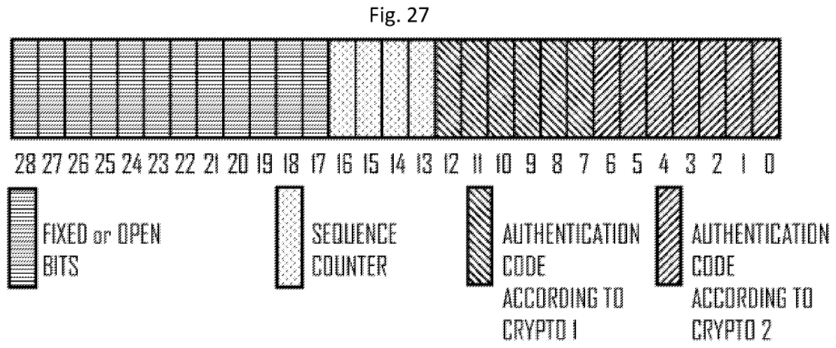

Another example illustrated in FIG. 27 uses 11 bits for the message identification. Then the Basic CAN identifier would identify the message and the extended part the identifier of Extended CAN would be used purely for the encryption of the identifier of the command order that the receiver would demand in order to execute the demand. The advantage with this implementation is that there are a multitude of legacy CAN system designs based on Basic CAN with 11-bit identifiers that are working perfectly but not considered safe according to current standards. Such designs could be easily upgraded by changing the CAN transceiver to a new one supporting the innovation and extending the current Basic CAN identifier to an Extended CAN identifier. Here, the Basic CAN Identifier is the command code. Any tool could read the command on the CAN bus by neglecting the extension part of the identifier. The first four bits of the Extended CAN Identifier is a counter incremented by the transmitter to certify that old messages are not sent undetected by gateways. It can also be used to switch encryption keywords at each message. The counter is followed by a weaker encryption that would allow the executing node to exercise the command at specific conditions. The last part is generated by a strong encryption method and a match is required if the executing node should exercise the command.

1.-46. (canceled)

47. A method of operation for a first communication node communicating on a common control network, the method comprising:
communicating from a communication port of the first communication node onto the common control network a first part of a message packet configured to identify message content contained in the message packet and a second part of the message packet;
changing the second part of the message packet in response to a trigger;
storing in a memory associated with the first communication node a set of authorized changing portions of message packets associated with communication nodes on the common control network;
changing the authorized changing portions of the message packets associated with the communication nodes on the common control network;
comparing a received message packet's changing portion with the set of the authorized changing portions to determine whether the received message packet is authorized for the common control network;
discarding or ignoring the received message packet in response to the received message packet's changing portion not matching at least one of the authorized changing portions in the set of the authorized changing portions.

48. The method of claim 47 further comprising, in response to receiving the received message packet's changing portion not matching at least one of the authorized changing portions in the set of the authorized changing portions, sending an alert message on the common control network configured to cause a change in status of the communication nodes on the common control network.

49. The method of claim 48 further comprising, in response to receiving an alert message from one of the communication nodes on the common control network, changing the second part of the message packet sent from the communication port.

50. The method of claim 49 further comprising, in response to receiving a message from one of the communication nodes on the common control network, waiting for a given time before sending a message, the given time sufficient to allow for detection of an unauthorized message and receipt of the alert message.

51. The method of claim 47 further comprising changing the second part of the message packet in response to one of the group consisting of:
passage of a given time period, receipt of a given number of received messages, sending of a given number of sent messages, receipt of an alert message at the communication port, combinations thereof.

52. The method of claim 47 further comprising changing the second part of the message packet by switching to a different value in a lookup table.

53. The method of claim 47 further comprising communicating from the communication port a third part of the message packet configured to change and to change the third part of the message packet using an algorithm different from an algorithm used to change the second part of the message packet.

54. The method of claim 53 further comprising sending the message packet with the third part using an algorithm different from the second part of the message packet in response to a state of a systems for the common control network being in a sensitive state.

55. (canceled)

56. The method of claim 47 wherein the first part is scattered over at least a portion of the second part of the message packet.

57. The method of claim 47 further comprising communicating from the communication port a third portion of the message packet that includes semi dynamic bits.

58. The method of claim 57 wherein the semi dynamic bits are scattered over at least a portion of the second part of the message packet.

59. A communication node apparatus comprising a communication port comprising a processing device, wherein the communication port is configured to:
effect communication from the communication node apparatus onto a common control network a first part of a message packet configured to identify message content contained in the message packet and a second part of the message packet;
change the second part of the message packet in response to a trigger;
store in a memory associated with the first communication node a set of authorized changing portions of message packets associated with communication nodes on the common control network;
change the authorized changing portions of the message packets associated with the communication nodes on the common control network;
compare a received message packet's changing portion with the set of the authorized changing portions to determine whether the received message packet is authorized for the common control network;
discard or ignore the received message packet in response to the received message packet's changing portion not matching at least one of the authorized changing portions in the set of the authorized changing portions.

60. The communication node apparatus of claim 59 further comprising, in response to receiving the received message packet's changing portion not matching at least one of the authorized changing portions in the set of the authorized changing portions, sending an alert message on the common control network configured to cause a change in status of the communication nodes on the common control network.

61. The communication node apparatus of claim 60 wherein the communication port is further configured to, in response to receiving an alert message from one of the communication nodes on the common control network, change the second part of the message packet sent from the communication port.

62. The communication node apparatus of claim 61 wherein the communication port is further configured to, in response to receiving a message from one of the communication nodes on the common control network, wait for a given time before sending a message, the given time sufficient to allow for detection of an unauthorized message and receipt of the alert message.

63. The communication node apparatus of claim 59 wherein the communication port is further configured to change the second part of the message packet in response to one of the group consisting of: passage of a given time period, receipt of a given number of received messages, sending of a given number of sent messages, receipt of an alert message at the communication port, combinations thereof.

64. The communication node apparatus of claim 59 wherein the communication port is further configured to change the second part of the message packet by switching to a different value in a lookup table.

65. The communication node apparatus of claim 59 wherein the communication port is further configured to communicate a third part of the message packet configured to change and to change the third part of the message packet using an algorithm different from an algorithm used to change the second part of the message packet.

66. The communication node apparatus of claim 65 wherein the communication port is further configured to send the message packet with the third part using an algorithm different from the second part of the message packet in response to a state of a systems for the common control network being in a sensitive state.

67. The communication node apparatus of claim 59 wherein the first part is scattered over at least a portion of the second part of the message packet.

68. The communication node apparatus of claim 59 wherein the communication port is further configured to communicate a third portion of the message packet that includes semi dynamic bits.

69. The communication node apparatus of claim 68 wherein the semi dynamic bits are scattered over at least a portion of the second part of the message packet.
